(19) United States
(12) Patent Application Publication
(10) Pub. No.: US 2018/0238355 A1
(43) Pub. Date: Aug. 23, 2018

(54) PNEUMATIC LINEAR ACTUATOR FOR A VEHICLE COMPONENT

(71) Applicant: KA Group AG, Zurich (CH)

(72) Inventor: Pawel ZABIELSKI, Krakow (PL)

(21) Appl. No.: 15/886,421

(22) Filed: Feb. 1, 2018

(30) Foreign Application Priority Data
Feb. 17, 2017 (DE) 102017103315.7

(51) Int. Cl. F15B 15/10; B60N 2/66

(52) U.S. Cl. CPC F15B 15/10; A47C 7/467; B60N 2/665

(57) ABSTRACT

The invention relates to a pneumatic linear actuator to adjust the contour or shape of a vehicle component, comprising an air cell arrangement with a plurality of inflatable air cells arranged in series in a longitudinal direction and fluidly interconnected by a channel, wherein a guiding rod extends through the channel and is firmly connected with a first end of the air cell arrangement, wherein at the second end of the air cell arrangement a passage opening is provided through which the guiding rod extends and is guided in a displaceable manner, such that by introduction of pressurized air into the air cells, the air cells expand in the longitudinal direction and displace the second end along the guiding rod in longitudinal direction, and wherein a tube is hermetically attached to the passage opening in the second end of the air cell arrangement and receives the second end of the guiding rod in a displaceable manner.

The invention relates to a pneumatic linear actuator to adjust the contour or shape of a vehicle component comprising a plurality of inflatable air cells arranged successively in series, wherein the air cells can be connected to a source for pressurized air such that by introducing pressurized air into the air cells, the series of air cells expands in longitudinal direction.

Pneumatic linear actuators are used in various arrangements to adjust the contour and shape of vehicle components, such as vehicle seats. Adjustment of the shape of the vehicle seat is desired in terms of individual physical comfort and healthcare, because the seat contour can be adjusted to the personal needs of the passenger. Pain and discomfort that may occur over long periods of driving may be prevented thereby. The selective adjustment by means of pneumatic linear actuators includes among other things adjustment of the shape, in particular extending the seating area, as well as adjustment of the back rest and the head rest.

DE 10 2009 057 435 A1 discloses a seat whose seat depth is adjustable. A front part of the seat is mounted on a carrier plate which is displaceable along a rail guide relative to a fixed seating part in longitudinal direction. A bellows can be supplied with compressed air to serve as adjusting member. The bellows is arranged underneath the carrier plate. The arrangement of guidance and bellows is comparatively expensive and requires a respectively large installation place. Further, it cannot be excluded that the bellows bends to the side or detaches as a result of transversal loads exerted.

A similar arrangement is found in U.S. Pat. No. 9,010,858 B2. This document describes a vehicle seat with a fixed sitting part and a movable sitting part. A guiding rod is fixed to the movable sitting part and is guided displaceably in longitudinal direction in the fixed sitting part. Between the movable and the fixed sitting part, underneath the guide rod guidance, is an inflatable bellows which displaces the movable sitting part relative to the fixed sitting part by volume change.

US 2008/0191531 A1 describes a vehicle seat with a fixed and a movable sitting part that is displaceable relative to the fixed part. The fixed sitting part comprises a guidance, in which a guiding rod is guided displaceably in longitudinal direction. The guiding rod has a T-shaped end that is firmly attached to the movable sitting part. A bellows encompasses the guiding rod and is with its front end firmly attached to the movable sitting part. The opposite end of the bellows is attached to the fixed sitting part or to the T-shaped end of the guiding rod such that the bellows forms an enclosed interior space in which the longitudinally displaceably guided guiding rod is accommodated. By change of volume of the bellows, the moveable sitting part is displaced relative to the fixed sitting part.

The above described adjustment mechanisms show some disadvantages, in particular since the air cushion has to be attached to the respective counterpart in an airtight manner during installation, wherein the sealing is connected with considerable expense and costs. Further, the expansion of the inflatable components is problematic. Because the air cushion can only be installed at opposite fixation points, it is possible that the air cushion moves or bends to the side, which impairs the function and operational safety of the linear actuator.

It is object of the present invention to provide a pneumatic linear actuator that can be manufactured at low costs. Further, a high level of operational safety shall be provided.

The object of the invention is solved by a pneumatic linear actuator as defined in claim 1 as well as by a vehicle component as defined in claim 10. Preferred embodiments of the present invention are set out in the dependent claims.

According to the invention, the inflatable air cells, which are arranged in series in longitudinal direction, form an air cell arrangement through which a central channel extends and that interconnects the air cells. Via the central channel the air cells, which can be connected to a source for pressurized air, are fluidly interconnected. A guiding rod extends through the central channel from a first end of the guiding rod (first guiding rod end) to the second end of the guiding rod (second guiding rod end), wherein the air cell arrangement extends along the guiding rod from a first end of the air cell arrangement to a second end of the air cell arrangement opposite the first end. The first end of the air cell arrangement is firmly connected to the first end of the guiding rod. A passage opening is provided at the second end of the air cell arrangement, and the guiding rod extends through the passage opening in a displaceable and guided manner such that the series of air cells expands in the longitudinal direction along the guiding rod while displacing the second end of the air cell arrangement along the guiding rod in longitudinal direction when pressurized air is introduced into the air cells. The pneumatic linear actuator further comprises a tube attached to the passage opening in the second end of the air cell arrangement, wherein the tube receives the second end of the guiding rod in a displaceable manner, and wherein the tube hermetically seals the passage opening of the air cell arrangement, and wherein an opening of the tube facing away from the passage opening is located at a distance from the second end of the guiding rod and is hermetically closed.

The series of air cells extends in a longitudinal direction, respectively along a longitudinal axis, from the first end to the second end of the air cell arrangement. Likewise, the guiding rod extends in the longitudinal direction, respectively along the longitudinal axis. The tube functions as receptacle for the second guiding rod end and extends away from the series of air cells in longitudinal direction.

The tube is attached to the passage opening with its first end and is in fluid connection with the inside of the air cells, whereas the opposite, second end of the tube comprises an air-tight closure. The guiding rod is retracted into, respectively extended from the tube, via the passage opening and the open first end of the tube when the series of air cells expands or contracts. The air cells can be supplied with pressurized air, e.g., by a pump via valve control.

The closed second end of the tube is arranged at a distance from the second guiding rod end, which may reciprocate in the tube, such that the closed end of the tube is moved away from the second guiding rod end, respectively moved towards the second guiding rod end, when the air cells expand or contract.

The first end of the series of air cells is with respect to the guiding rod provided as fixed end, whereas the second end of the series of air cells is with respect to the guiding rod provided as movable end. The series of air cells forms the air cell arrangement.

Within the meaning of the invention, the term “tube” includes any form of elongated body suitable to receive the guiding rod in longitudinal direction in a displaceable manner. This includes in particular elongated bodies with angular, oval or other round cross-sections.

By introducing pressurized air the series of air cells can be transformed from a contracted state (1st position) into an expanded state (2nd position), by what the length variation of the pneumatic linear actuator is adjusted. The series of air cells is guided in longitudinal direction by the guiding rod during contraction as well as during expansion. A sliding seal between the guiding rod and the movable end of the series of air cells may be omitted due to the sealing tube. As a result, the susceptibility to failure is significantly reduced and the manufacturing is simplified.

According to further embodiment of the invention, the end of the tube facing away from the air cells is closed by a separate cap. This includes lids, plugs or other suitable closing means. Preferably, a permanent closure is provided by welding or glueing.

In accordance with a further embodiment of the invention, the second movable end of the series of air cells is guided on the guiding rod. A guidance of the second movable end of the series of air cells can comprise a guiding pin or a guiding ring at the last air cell of the air cell arrangement, wherein the guiding pin or the guiding ring at least partially surrounds the guiding rod.

According to a further embodiment of the invention, the tube is flexible. Thereby, assembly of the linear actuator is simplified.

According to a further embodiment of the invention, adjacent air cells are connected by a section that is guided on the guiding rod in longitudinal direction (i.e., along the longitudinal axis, respectively in longitudinal direction), such that the deflection of the air cells in a direction transverse to the longitudinal axis is effectively limited by the guiding rod. This significantly improves operational safety. It is also possible to integrate multiple guiding rods into the linear actuator to improve guiding stability. The guiding rods can be provided in different sections of the linear actuator.

According to a further embodiment of the invention, the section that connects adjacent air cells provides the fluid connection between adjacent air cells. In this sense, the connecting section can form an annular opening that has a larger diameter than the outer diameter of the guiding rod such that air can be exchanged through a gap between the guiding rod and the opening.

According to a further embodiment of the invention, the first end of the series of air cells comprises a spigot that receives the first end of the guiding rod. The spigot preferably extends relative to the inside of the air cell arrangement in outer direction. The spigot can comprise a closed end such that the series of air cells can be supported by the spigot on the first end of the guiding rod when the guiding rod is inserted into the spigot. According to a further embodiment of the invention, the spigot and the guiding rod are welded together.

According to a further embodiment of the invention, the first end of the air cell arrangement and the second end of the air cell arrangement are each fixed to a carrier element, wherein the guiding rod is guided on the carrier elements. By expansion and contraction of the air cell arrangement/the series of air cells the carrier elements are positioned relative to one another in longitudinal direction.

According to a further embodiment of the invention, the first end and the second end of the air cell arrangement are coupled to each other by at least one return spring. The return spring can be attached to both carrier elements. By means of the return spring a pneumatic linear actuator can be retracted from the expanded state into the contracted state, e.g., by opening an outlet valve.

The invention is also directed to a vehicle component, in particular a vehicle seat, with an inflating system for a plurality of air cells and at least two components, e.g. seat elements, that are displaceable relative to each other. The vehicle component comprises a pneumatic linear actuator as described herein, wherein the air cells are connected to the inflating system and the first end and the second end of the series of air cells are respectively connected to one of the displaceable components such that the relative position of the components is adjustable by introducing pressurized air into the air cells.

Further advantages of the present invention will be become apparent to those of ordinary skill in the art by reading the following detailed description of an exemplary embodiment and the drawings. It shows:

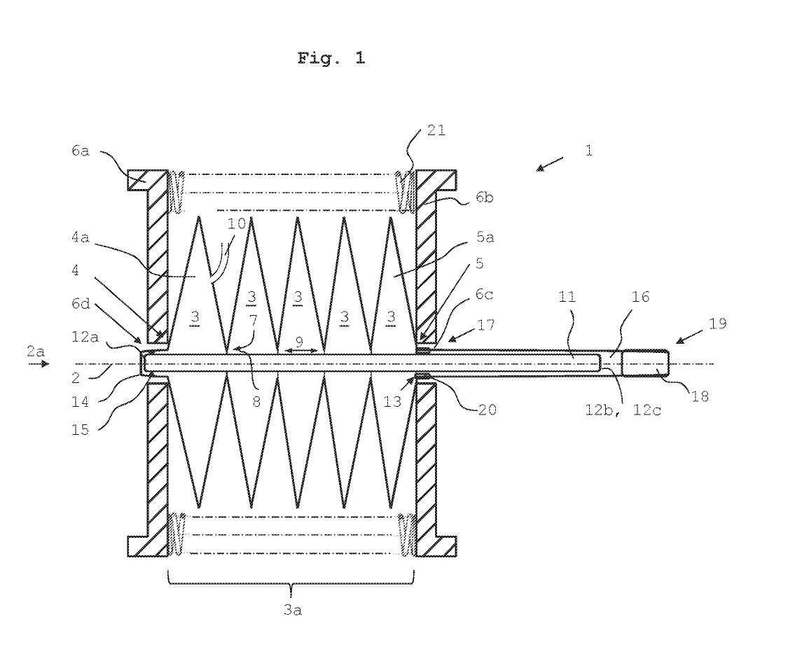

FIG. 1 schematically a cut view through a pneumatic linear actuator in accordance with a first embodiment of the invention in a first position; and

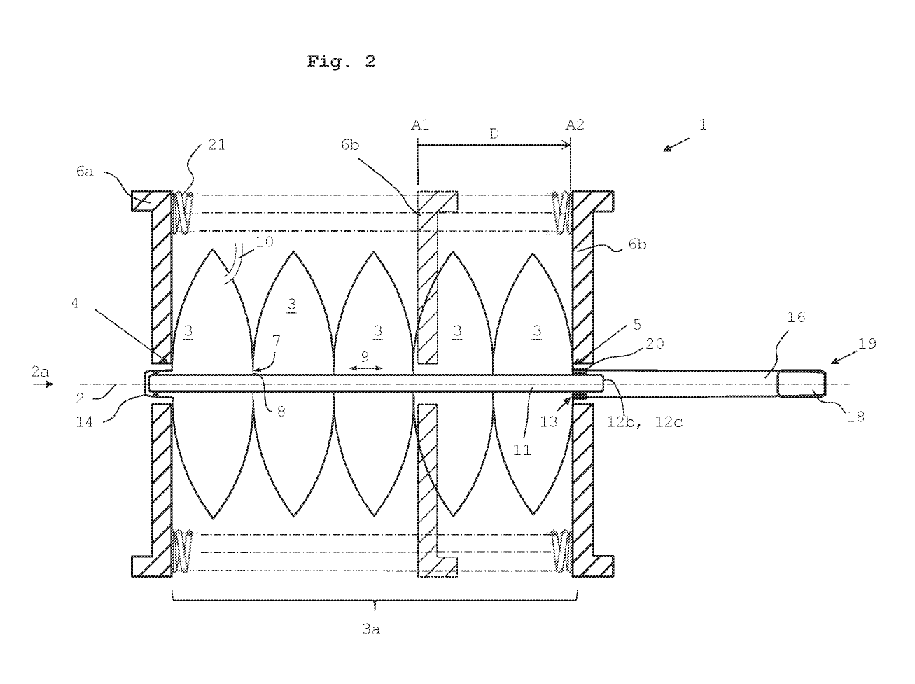

FIG. 2 the pneumatic linear actuator according to FIG. 1 in a second position.

FIG. 1 shows a pneumatic linear actuator 1 that can be integrated into the frame of a vehicle seat for relative positioning of sections of the vehicle seat and for adapting the contour, respectively the outer shape, of the vehicle seat. The pneumatic linear actuator 1 in FIG. 1 is in a driven-into state, non-expanded or retracted state and extends in longitudinal direction 2a along the longitudinal axis 2.

Along the longitudinal axis 2 in longitudinal direction 2a there are a plurality of flexible, inflatable air cells 3 arranged in series behind each other, thereby forming an air cell arrangement 3a. By supplying pressurized air into the air cells 3, the air cells 3 change their volume and expand in longitudinal direction 2a. The number, size and stiffness of the air cells may be chosen in dependence of the desired displacement or the required displacing force. The series of air cells 3 extends in longitudinal direction 2a from a first end 4 to a second end 5 at the opposite end of the series of air cells. The first end 4 and the second end 5 are at opposite ends of the air cell arrangement 3a.

The first air cell 4a that is provided in longitudinal direction 2a at the first end 4 is arranged in longitudinal direction at a first carrier element 6a, whereas the last air cell 5a at the second end 5 is arranged in longitudinal direction at a second carrier element 6b such that the air cell arrangement 3a is arranged in longitudinal direction between the two carrier elements 6a, 6b. The carrier elements 6a, 6b may each be attached to one of the two vehicle seat components that are movable relative to each other and may be displaced along the longitudinal axis 2 by a guidance (not shown).

Adjacent air cells are connected to each other by a central connecting section 7 that extends around the longitudinal axis 2. The connecting section 7 forms, when viewed in longitudinal direction, an annular opening 8 that connects the inside of adjacent air cells 3 such that adjacent air cells 3 are fluidly connected to each other. The connecting sections are part of a central channel 9 that extends along the longitudinal axis 2 through the series of air cells 3. Due to the connecting section 7 and the annular openings 8, all air cells 3 are fluidly interconnected.

The first air cell 4a is provided with an inlet 10. Pressurized air from a pressurized air source (not shown) can be supplied into the first air cell 4a via the inlet.

A guiding rod 11 extends along the longitudinal axis 2 through the central channel 9 of the series of air cells 3. The guiding rod 11 comprises a first end 12a (first rod end) and a second end 12b (second rod end) at the opposite end of the guiding rod 11.

The first end 12a of the guiding rod 11 is arranged at the first end 4 of the air cell arrangement 3a, respectively at the first carrier element 6b. From the first guiding rod end 12a the guiding rod 11 extends through the central channel 9 through the series of air cells 3. In the second end 5 of the air cell arrangement 3a, that is at the last air cell 5a, a passage opening 13 is formed in the sidewall of the last air cell 5a. The guiding rod 11 extends through the passage opening 13 in the second end 5 and through an opening 6c in the second carrier element 6b and beyond the second carrier element 6b to end in a front side 12c of the second end 12b of the guiding rod 11.

The first end 12a of the guiding rod 11 is received in a spigot 14, which is formed in a central wall section of the first air cell 4a and which extends in relation to the inside of the air cell arrangement 3a to the outside. The rod end 12a is firmly connected to the spigot 14 by a welding connection 15. The spigot 14 is received in a central opening 6d of the first carrier element 6a.

In longitudinal direction 2a at the opposite end of the guiding rod 11 there is a tube 16 connected to the passage opening 13 of the air cell arrangement. The tube 16 extends away from the first end 4, the second end 5 and the second carrier element 6b in longitudinal direction 2. The tube 16 comprises a first open end 17 that is connected to the passage opening 13, and a second end 19 that is hermetically sealed by a cap 18. The last air cell 5a and the inside of the tube 16 are thereby in fluid connection. The tube 16 is welded to the air cell arrangement and seals the passage opening 13 in an air tight manner. Pressurized air can only be introduced into the air cell arrangement via the inlet 10, respectively pressurized air can only be released through the inlet 10. Of course, further inlets and outlets can be provided.

At the second end of the last air cell 5a a connecting piece 20 is centrally attached to the passage opening 13, the connecting piece 20 serving as connecting element between the last air cell 5a and the tube 16. At the same time, the connecting piece 20 provides guidance for the guiding rod 11 in longitudinal direction. Further, the guiding rod 11 is guided in the opening 6c of the carrier element 6b.

The guiding rod 11 is received in the tube 16 in a longitudinally displaceable manner and can be moved relative to the tube 16 along the longitudinal axis 2. In the retracted position of the series of air cells (FIG. 1) the second end 12b of the guiding rod 11 is spaced from the closed end 19 of the tube 16.

Since the first end 4 of the series of air cells 3 is firmly attached to the guiding rod 11 by the spigot 14, the first end 4 can be referred to as a fixed end. The opposite end of the air cell arrangement 3, the second end 5, is in relation to the guiding rod 11 moveable, respectively displaceable, in longitudinal direction along the longitudinal axis 2. In relation to the first end 4, the second end 5 is a non-fixed, movable end. When the second end 5 is moved together with the second carrier element 6b along the longitudinal axis 2, then the second end 5, respectively the second carrier element 6b, moves in longitudinal direction relative to the guiding rod 11, respectively along the guiding rod.

Between the two carrier elements 6a and 6b are provided return springs 21 at the outer edges of the carrier elements 6a, 6b. The return springs 21 are each connected to the first and the second carrier elements 6a, 6b. In the compressed state of the series of air cells, the springs 21 are relieved.

FIG. 2 shows the pneumatic linear actuator in the expanded state. In order to extend the pneumatic linear actuator, pressurized air is supplied via the inlet 10 into the air cells 3, wherein the air is distributed via the central channel 9 into the single air cells 3. By introducing pressurized air into the air cells 3, the volume of the air cells 3 changes and the air cells 3 expand along the longitudinal axis 2. During the expansion, the air cells 3 are guided on the guiding rod 11 by the annular openings 8 in the connecting sections 7 and cannot deflect in a direction perpendicular/transverse to the longitudinal axis 2.

Due to the expansion of the air cells, the second carrier element 6b is displaced by the air cell arrangement 3a from the position A1, indicated by broken lines, along the longitudinal axis 2 and the guiding rod 11 over the distance D into the position A2. The guiding rod 11, which is fixed with the first end 4 in the spigot 14, is in relation to the moving second end 5, respectively the moving second carrier element 6b, fixed such that the second carrier element 6b, the connecting piece 20 and the tube 16 move along the guiding rod 11 away from the first carrier element 6a. The front end 12b of the guiding rod is moved in the tube 16 in backward direction until reaching the position shown in FIG. 2. By the relative movements, the return springs 21 are tensioned.

When air is released out of the inlet 10 by means of a valve (not shown) and out of the air cells 3, the pretensioned tension springs 21 act such as to draw the carrier elements 6a and 6b back together, respectively towards one another. Thereby, the front end 12a of the guiding rod 11 drives deeper into the tube 16 and approaches the closed end 19 of the tube 16. The displacement path D between the carrier elements can be adjusted by controlling the compressed air supply.

### REFERENCE NUMERALS

1 pneumatic linear actuator
2 longitudinal axis
2a longitudinal direction
3 air cells
3a air cell arrangement
4 first end of air cell arrangement
4a first air cell at first end
5 second end of air cell arrangement
5a last air cell at second end
6a first carrier element
6b second carrier element
6c central opening in second carrier element
6d central opening in first carrier element
7 connecting section
8 annular opening
9 central channel
10 inlet
11 guiding rod
12a first end of guiding rod
12b second end of guiding rod
12c face side of guiding rod
13 passage opening
14 spigot
15 welding connection
16 tube
17 first end of tube
18 cap
19 second end of tube
20 connecting piece
21 return spring
D displacement path

1. A pneumatic linear actuator for a vehicle component to adjust the contour or shape of the component comprising:
an air cell arrangement with a plurality of inflatable air cells arranged in series in a longitudinal direction, wherein the series of air cells are fluidly interconnected by a channel extending through the series of air cells, wherein the air cells can be connected to a source for pressurized air; and
a guiding rod extending through the channel from the first end of the guiding rod to a second end of the guiding rod, wherein the air cell arrangement extends along the guiding rod from a first end to a second end opposite the first end;
wherein the first end of the air cell arrangement is firmly connected to the first end of the guiding rod and wherein a passage opening is provided at the second end of the air cell arrangement, wherein the guiding rod extends through the passage opening in a displaceable and guided manner such that the series of air cells expands in the longitudinal direction along the guiding rod while displacing the second end of the air cell arrangement along the guiding rod in longitudinal direction when pressurized air is introduced into the air cells; and
a tube attached to the passage opening in the second end of the air cell arrangement, wherein the tube receives the second end of the guiding rod in a displaceable manner, wherein the tube hermetically seals the passage opening in the second end of the air cell arrangement, and wherein an opening of the tube facing away from the passage opening is located at a distance from the second end of the guiding rod and is hermetically closed.

2. The pneumatic linear actuator according to claim 1, wherein the second end of the air cell arrangement is guided on the guiding rod.

3. The pneumatic linear actuator according to claim 1, wherein the tube is flexible.

4. The pneumatic linear actuator according to claim 1, wherein the air cell arrangement comprises an inlet for pressurized air.

5. The pneumatic linear actuator according to claim 1, wherein adjacent air cells are connected by a section that is guided on the guiding rod in longitudinal direction.

6. The pneumatic linear actuator according to claim 5, wherein the section that connects adjacent air cells surrounds the guiding rod and is configured such as to provide a fluid connection between adjacent air cells.

7. The pneumatic linear actuator according to claim 1, wherein the first end of the air cell arrangement comprises a spigot that receives the first end of the guiding rod.

8. The pneumatic linear actuator according to claim 7, wherein the spigot and the guiding rod are welded to each other.

9. The pneumatic linear actuator according to claim 1, wherein the first end of the series of air cells and the second end of the series of air cells are each fixed to a carrier element, wherein the guiding rod is guided on the carrier elements.

10. The vehicle component, in particular a vehicle seat, with an inflating system for a plurality of air cells and at least two components that are displaceable relative to each other, wherein the vehicle component comprises a pneumatic linear actuator according to claim 1, wherein the air cells are connected to the inflating system and the first end and the second end of the series of air cells are respectively connected to one of the displaceable components such that the relative position of the components is adjustable by introducing pressurized air into the air cells.

11. The pneumatic linear actuator according to claim 9 further comprising one or more return springs, each of said one or more return springs connected to the first and the second carrier elements such that, in the compressed state of the series of air cells, the one or more return springs are relieved.

12. The pneumatic linear actuator according to claim 9 further comprising two return springs, each of said two return springs connected to the first and the second carrier elements such that, in the compressed state of the series of air cells, the one or more return springs are relieved.

13. The pneumatic linear actuator according to claim 1 further comprising a connecting piece attached to the second end of the air cell arrangement and the passage opening, the connecting piece connecting a last air cell and the tube and also providing guidance for the guiding rod in longitudinal direction.

14. The pneumatic linear actuator according to claim 1, wherein the second end of the tube is hermetically sealed by a cap.

15. The pneumatic linear actuator according to claim 4, wherein pressurized air can only be introduced into the air cell arrangement via the inlet.

16. The pneumatic linear actuator according to claim 1 comprising more than one inlet for pressurized air.
